(19) United States
(12) Patent Application Publication
(10) Pub. No.: US 2015/0197054 A1
(43) Pub. Date: Jul. 16, 2015

(54) PREDICTING A CHARACTERISTIC OF AN INJECTION MOLDED ARTICLE

(71) Applicant: Plastic Technologies, Inc., Holland, OH (US)

(72) Inventors: Christopher William White, Maumee, OH (US); Donald Wayne Miller, Waterville, OH (US); Scott Steele, Perrysburg, OH (US)

(21) Appl. No.: 14/598,623

(22) Filed: Jan. 16, 2015

Related U.S. Application Data
(60) Provisional application No. 61/928,075, filed on Jan. 16, 2014.

(51) Int. Cl. B29C 45/77

(52) U.S. Cl. CPC B29C 45/77

(57) ABSTRACT

A method of manufacturing injection molded articles is disclosed, the method comprises steps of providing an injection molding apparatus having a pressure sensor, determining a relationship between injection pressure and intrinsic viscosity of a molten polymer for the injection molding apparatus, injection molding an article using the injection molding apparatus, determining an intrinsic viscosity of the article based on the injection pressure of the injection molding step in accordance with the relationship using a converter, and modifying or intervening in the operation of the injection molding apparatus.

### CROSS-REFERENCE TO RELATED APPLICATIONS

This application claims the benefit of U.S. Provisional Application No. 61/928,075, filed on Jan. 16, 2014. The entire disclosure of the above application is incorporated herein by reference.

### FIELD

The present invention relates to analyzing a characteristic of an injection molded article, and more particularly to predicting an intrinsic viscosity of an injection molded article during an injection molding process.

### INTRODUCTION

This section provides background information related to the present disclosure which is not necessarily prior art.

The molecular structure of a synthetic polymer can determine its end use and its process characteristics, such as hardness, tensile strength, drawability, elastic modulus, melt intrinsic viscosity, and solution intrinsic viscosity. These characteristics can be affected by temperature and pressure variations during an injection molding process.

Excessive loss of intrinsic viscosity is a concerning defect during injection molding of polymeric preforms because such loss may go undetected until hundreds or even thousands of preforms are injection molded or subsequently blow molded into containers. Containers with low intrinsic viscosity may not meet the performance requirements for thermal stability, stress crack resistance, creep resistance, burst pressure, and the like. Containers made from preforms having an excessive intrinsic viscosity loss defect can fail in storage, during transportation, and even in retail locations.

Thus, it would be desirable to develop a way of predicting the intrinsic viscosity of an injection molded article during the injection molding process, thereby indicating when an article may have a defect and allowing an intervention in the injection molding process before a large number of articles exhibiting the intrinsic viscosity loss defect are produced.

### SUMMARY

The present technology includes various embodiments of an apparatus, a system, and a method to determine an intrinsic viscosity of an injection molded article during an injection molding process. It is an object of the present technology to predict the intrinsic viscosity of an injection molded article based on a relationship between the intrinsic viscosity of an article molded from a molten polymer and the injection pressure of the molten polymer.

An injection molding apparatus according to the present technology includes an injection unit, a conduit, a pressure sensor, and a converter. The injection unit includes a piston that is configured to force a molten polymer through a bore. The conduit includes a fluid, where the conduit is fluidly coupled to the injection unit and the fluid is configured to actuate the piston of the injection unit to force the molten polymer through the bore. The pressure sensor is coupled to the conduit, where the pressure sensor is configured to provide a pressure measurement of the fluid within the conduit. The converter is configured to receive the pressure measurement of the fluid within the conduit from the pressure sensor and is operable to convert the pressure measurement to an intrinsic viscosity value.

A method of operating an injection molding apparatus is provided by the present technology. A pressure of a fluid is measured to obtain a pressure measurement, where the fluid is configured to actuate a piston of an injection unit. The pressure measurement is converted to an intrinsic viscosity value. An indication of when the intrinsic viscosity value falls below a threshold value or is outside of a range is then provided. For example, the indication can include one or more of a visual signal, an audible signal, an electronic signal, and a wireless signal. The method can also further include intervening in an operation of the injection molding apparatus when the intrinsic viscosity value falls below a threshold value or is outside of a range. Various ways of intervening include one or more of: (a) interrupting operation of the injection molding apparatus; (b) recording that an injection molded article has an intrinsic viscosity loss defect; (c) checking a dew point of a dryer of the injection molding apparatus; (d) checking an airflow of the dryer of the injection molding apparatus; (e) checking a loading condition of the dryer of the injection molding apparatus; (f) verifying a polymer recipe of the injection molding apparatus; (g) checking a polymer additive of the injection molding apparatus; (h) verifying a temperature of the injection molding apparatus; (i) calibrating a temperature sensor of the injection molding apparatus; and (j) checking a mold parameter of the injection molding apparatus.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic of injection molding apparatus according to the present technology.

FIG. 2 graphically depicts the relationship between the injection pressure of a molten polymer versus the intrinsic viscosity (IV) of an injection molded articled formed from the molten polymer.

FIG. 3 graphically depicts the relationship between injection molding cycles versus intrinsic viscosity of an article formed using an injection molding apparatus operated at a substantially uniform temperature of 520° F.

FIG. 4 graphically depicts the relationship between the solution intrinsic viscosity (SIV) of an article (a preform) formed using an injection molding apparatus and the melt viscosity of the polymer used to form the article.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding the methods disclosed, the order of the steps presented is exemplary in nature, and thus, the order of the steps can be different in various embodiments. Except where otherwise expressly indicated, all numerical quantities in this description are to be understood as modified by the word “about” in describing the broadest scope of the technology.

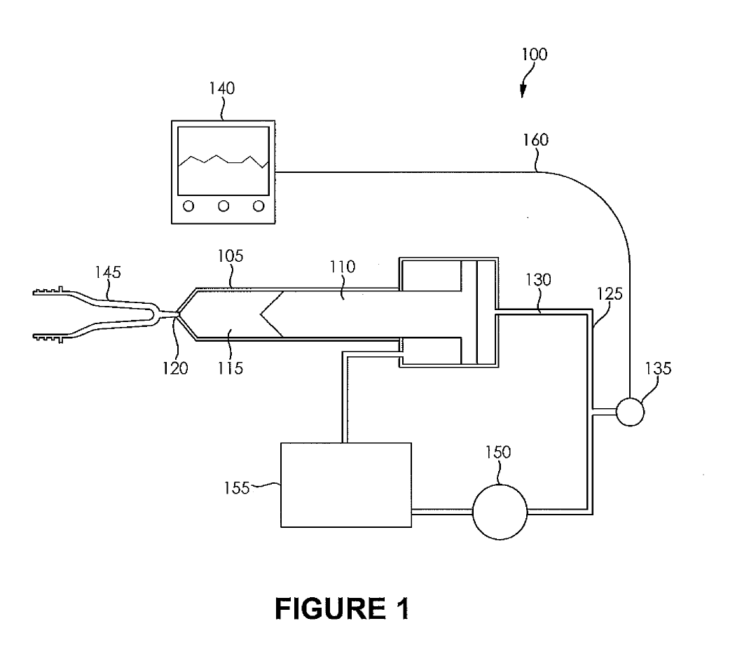

Various embodiments of an injection molding apparatus are provided by the present technology. In one embodiment, as depicted in FIG. 1, an injection molding apparatus 100 includes an injection unit 105 including a piston 110, where the piston 110 is configured to force a molten polymer 115 through a bore 120. A conduit 125 includes a fluid 130, where the conduit 125 is fluidly coupled to the injection unit 105 and the fluid 130 is configured to actuate the piston 110 of the injection unit 105 to force the molten polymer 115 through the bore 120. A pressure sensor 135 is coupled to the conduit 125, where the pressure sensor 135 is configured to provide a pressure measurement of the fluid 130 within the conduit 125. A converter 140 is configured to receive the pressure measurement of the fluid 130 within the conduit 125 from the pressure sensor 135, where the converter 140 is operable to convert the pressure measurement to an intrinsic viscosity value.

The injection molding apparatus 100 can include various additional aspects. A mold 145 can be fluidly coupled to the bore 120. The mold 145 can determine the shape of one or more injection molded articles. The injection molding apparatus 100 can further include a plasticizing unit (not shown) fluidly coupled to the injection unit, where the plasticizing unit is configured to provide the molten polymer 115 to the injection unit 105. For example, the plasticizing unit can include a plunger/piston type plasticizing unit or a screw type plasticizing unit along with one or more heaters to provide the molten polymer 115 to the injection unit 105. The injection molding apparatus can further include a pump 150 that is configured to pressurize the fluid 130 within the conduit 125 to actuate the piston 110 of the injection unit 105 to force the molten polymer 105 through the bore 120. A fluid reservoir 155 can be fluidly coupled to the conduit 125 and the pump 150 to hold a volume of the fluid 130. The pump 150 can be fluidly coupled to the injection unit 105 in more than one location and can be reversible in pumping direction, thereby allowing the pump 150 to pressurize the fluid 130 to actuate the piston 110 for injecting molten polymer 115 and to retract the piston 110 for refilling the injection unit 105 with molten polymer 115.

The pressure sensor 135 can be coupled to the conduit 125 at various positions, where as shown in FIG. 1, the pressure sensor 135 is coupled at a position between the pump 150 and the piston 110 of the injection unit 105. Embodiments of the pressure sensor 135 include various mechanical, electronic, and electromechanical pressure sensors. In certain embodiments, the pressure sensor 135 is an electronic pressure sensor. Examples of electronic pressure sensors 135 include a piezoresistive strain sensor, a capacitive sensor, a magnetic sensor, a piezoelectric sensor, an optical sensor, a potentiometric sensor, and a resonant sensor. More than one pressure sensor 135 can be coupled to the conduit 125, including a portion of the conduit 125 configured as part of the injection unit 105. The pressure sensor 135 can generate an electronic signal corresponding to a pressure measurement.

The converter 140 can be electrically coupled to the pressure sensor 135, via an electronic connection 160 as shown in FIG. 1, or the converter 140 can be in communication with the pressure sensor 135 in other ways. In certain embodiments, the converter 140 and the pressure sensor 135 can be formed as an integral unit. In some embodiments, the converter 140 can wirelessly receive the pressure measurement of the fluid 130 within the conduit 125 from the pressure sensor 135, allowing the converter 130 to be positioned remotely from the pressure sensor 135. The converter 140 can include an interface, display, or other means for providing an output or allowing a user to view the pressure measurement and/or the intrinsic viscosity value converted from the pressure measurement. Embodiments include where the converter 140 is configured to provide an indication of when the intrinsic viscosity value falls below a threshold value or is outside of a range. For example, the converter 140 can be programmable to allow a user to set the threshold value or the range.

The intrinsic viscosity threshold value or range can be dependent on various parameters of the injection molding apparatus 100 and the injection molding process. For example, the pressure measurement and the pressure measurement converted to an intrinsic viscosity value (e.g., where the pressure measurement is proportional to the intrinsic viscosity value) can be particular to one or more of a mold 145 configuration, a pressure measurement obtained at a point when the piston 110 of the injection unit 105 is forcing the molten polymer 115 through the bore 120, and an average of pressure measurements obtained at more than one point when the piston 110 of the injection unit 105 is forcing the molten polymer 115 through the bore 120.

Indication of when the intrinsic viscosity value falls below the threshold value or is outside of the range can be provided by the converter 140 in various ways. For example, the indication can include one or more of a visual signal, an audible signal, an electronic signal, and a wireless signal. In this manner, a user or operator of the injection molding apparatus 100 can receive the indication that the injection molded articles may have an intrinsic viscosity loss defect. The indication can also be provided to a controller configured receive the indication of when the intrinsic viscosity value falls below the threshold value or is outside of the range and thereby intervene in the operation of the injection molding apparatus. For example, the user or operator of the injection molding apparatus 100 can serve as a controller in certain embodiments or an automated controller, such as a programmable logic controller, can intervene in the injection molding process. In certain embodiments, the controller can be an integral part of the converter 140, where the converter 140 serves to receive the pressure measurement of the fluid 130 within the conduit 130 from the pressure sensor 135, the converter 140 converts the pressure measurement to an intrinsic viscosity value, and the converter 140 thereby can intervene in the operation of the injection molding apparatus 100. As noted herein, the converter 140 can be integrated with the pressure sensor 135, thus the operations of the controller, converter 140, and pressure sensor 135 can all be integrated within a single unit.

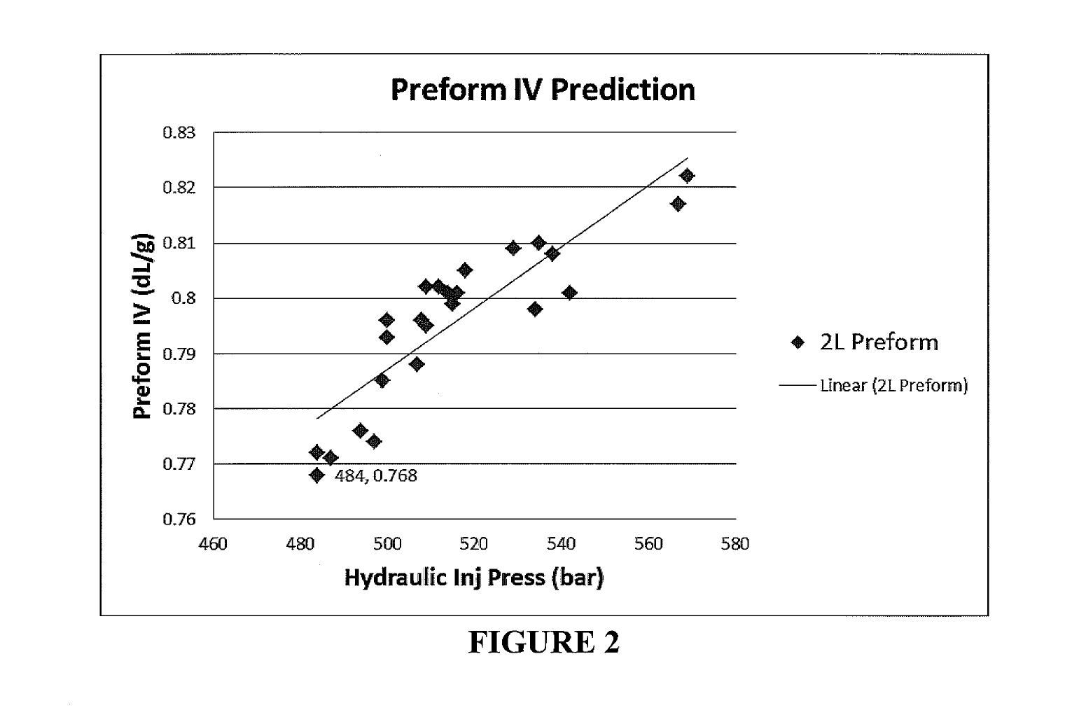

The present technology accordingly provides methods of predicting the intrinsic viscosity of an injection molded article, such as a preform, using the measurement of injection pressure by the pressure sensor 135. The method involves determining a relationship between the injection pressure of the molten polymer 115 with known characteristics versus the intrinsic viscosity of an injection molded article formed at varying injection pressures from the molten polymer 115. As shown in FIG. 2, as injection pressure increases, the intrinsic viscosity of the resulting molded article, in this case a preform, also increases. The known characteristics can include the intrinsic viscosity of the molten polymer 115, the particular makeup and blend of the molten polymer 115, and the water content of the molten polymer 115.

To determine the relationship shown in FIG. 2, an injection rate (and the related injection pressure measurement) of the injection molding process can be determined. Unlike in extrusion processes, where the extrusion rate through a known orifice is relatively constant, the injection pressure during an injection molding process can be dynamic. The injection pressure can vary based on when and where in the injection molding process the pressure is measured. For example, the injection pressure can be different during the initial injection phase from the pressure when the pressure levels out during injection of the body of the injection molded article, such as a blow molding preform. These pressures can be different still from the injection pressure during the injection step when the mold 145 is nearly full and during a packing pressure phase of the injection step.

To simplify the injection pressure profile for purposes of developing a relationship between injection pressure and intrinsic viscosity of the article, a resultant injection rate and/or a resultant injection pressure can be determined. The determination of a resultant injection rate and injection pressure is similar to the determination of an equivalent pipe length for determining pressure drop across various pipe diameters in parallel fluid flow. That is, the resultant injection rate and/or resultant injection pressure can be determined at a single point in the process and/or at a single location in the injection molding apparatus 100 (e.g., a certain location in the conduit 125) or by determining an average injection rate and/or an average injection pressure based on the different injection rates and injection pressures at different points or phases during the injection molding step and based on the amount of time each injection rate and/or injection pressure is used.

Factors used in determining the resultant injection rate and/or resultant injection pressure can vary from process to process based on a number of parameters. For example at a given intrinsic viscosity, a high injection rate can result in an elevated fill pressure and a low injection rate can result in a lower fill pressure. Also, a longer flow length can result in a higher pressure with a fixed intrinsic viscosity and fill rate. A greater wall thickness for the injection molded article can result in a lower pressure at a fixed fill speed, fixed intrinsic viscosity, and fixed flow length. A lesser wall thickness can increase the pressure in the same scenario. The flow rate, flow length, and wall thickness can vary within a typical process but are consistent from cycle to cycle if the injection molding apparatus 100 is capable and the molding environments are controlled. Then it is a matter of choosing and identifying the location in the injection molding cycle to analyze.

In the injection molding process, an injection molding apparatus 100 with a desired number of cavity molds 145 is provided. Articles are injection molded using one or more molds 145. The molten polymer 115, also referred to as a resin, having a known intrinsic viscosity and having a known water content, is used in the injection molding process. The temperature of the mold 145 is held substantially constant. The mold 145 can be held at a constant temperature manually by an operator or via a control system regulating, among other things, the temperature thereof. During the injection molding step, the injection pressure of the molten polymer 115 is monitored. During the initial injection molding cycle(s), the injection pressure during different phases of the injection molding process is monitored. The pressure sensor 135, for example as part of a control system, then determines a resultant injection pressure measurement (or a resultant injection rate) for the injection molding step of each cycle. A desired number of cycles can be run before a relatively consistent resultant injection pressure measurement, or a steady-state resultant injection pressure measurement, can be observed. For example, one cycle, more than five cycles, more than ten cycles, more than fifteen cycles, or more than twenty cycles can be run before the resultant injection pressure measurement of each cycle is relatively consistent.

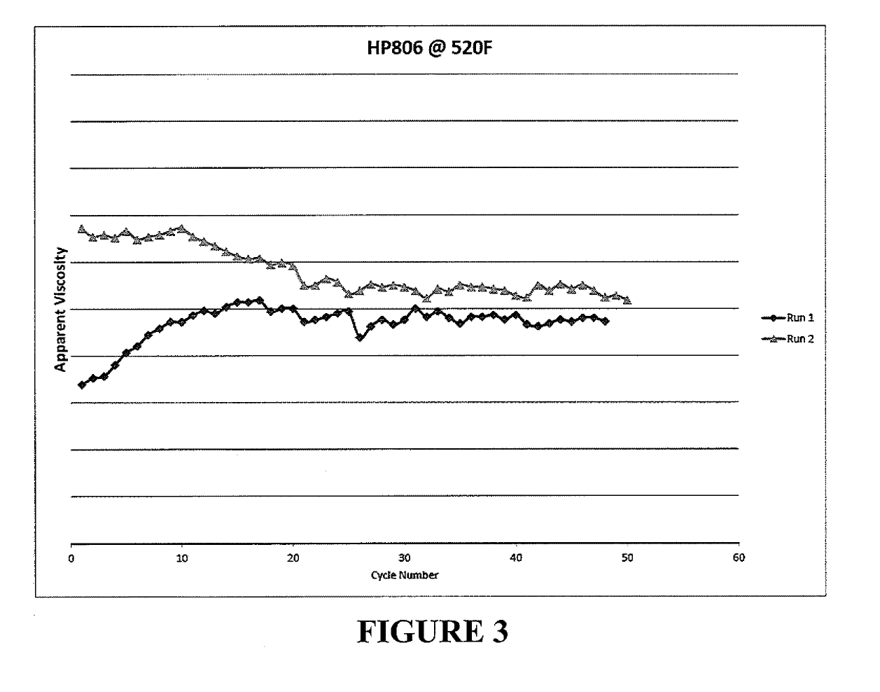

FIG. 3 shows a graph of the relationship between injection molding cycles versus intrinsic viscosity of the molded article for an injection molding apparatus 100 operated at a substantially uniform temperature of about 520° F. After the resultant injection pressure measurement is determined, the pressure sensor 135 monitors the injection pressure of each subsequent cycle.

A desired and acceptable range of intrinsic viscosities can depend on the application of the formed article. Examples of applications for polyethylene terephthalate (PET) articles include various containers for carbonated beverages and other products holding pressurized fluids. For carbonated or pressurized fluid containers, the minimum intrinsic viscosity can be the critical performance criteria. For carbonated beverages a minimum acceptable value can be about 0.80 dL/g. However, the intrinsic viscosity can be as low as about 0.78 dL/g. An upper limit of the intrinsic viscosity can be about 0.85 dL/g. Thus, a threshold or a range can be set for the pressure measurement converted to the intrinsic viscosity value.

For any cycles that fall below the desired threshold or outside of the desired range, the molded articles can be removed from the process line by an operator or via an operation controlled by the controller for subsequent intrinsic viscosity measurement to verify suitability. Verification for suitability can be determined using a capillary viscometer in accordance with ASTM method D4603 with a 60% phenol/40% tetrachloroethane solution with the PET concentration at 0.5% and a temperature of 30° C. The controller and/or the converter 140 can selectively provide an indication or intervention (e.g., an alarm) to indicate to an operator that the injection pressure has increased or decreased to an undesirable level, thus alerting the operator to a condition of the injection molding apparatus 100 or process step requiring attention. If the articles are ultimately determined to have a suitable intrinsic viscosity, they can be reintroduced into the process for further processing. If the articles do not have a suitable intrinsic viscosity, they can be destroyed or recycled.

The controller can also monitor the moisture content of the polymer resin and make adjustments to the relationship between the injection pressure and the intrinsic viscosity of the injection molded article to compensate for moisture content. For example, depending on the characteristics of the material being injection molded, a moisture content of 50 ppm can reduce the intrinsic viscosity of the preform by 0.05 dL/g.

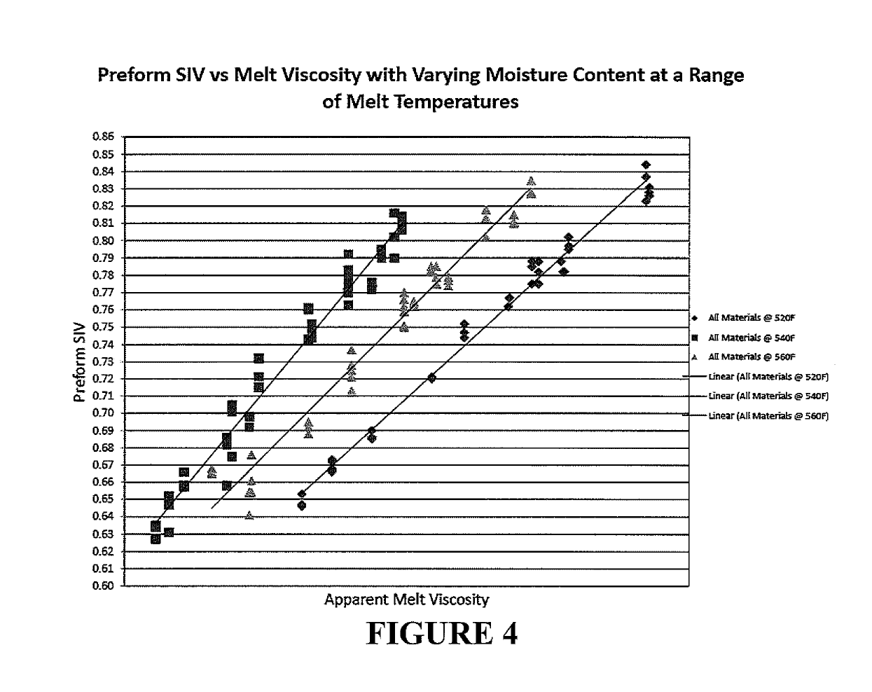

The present technology also provides various methods of predicting intrinsic viscosity of an injection molded article, such as a preform, using the melt viscosity of the polymer. A relationship between the solution intrinsic viscosity of a molded article (e.g., a preform) and the melt viscosity of the resin during injection molding is shown in FIG. 4. Similar to the method described above with respect to injection pressure and intrinsic viscosity, a relationship between melt viscosity of the resin and the intrinsic viscosity of the injection molded article can be determined by either keeping the melt intrinsic viscosity substantially constant, injection molding articles at varying melt intrinsic viscosities, and then measuring the intrinsic viscosity of the molded article. Alternatively, the relationship can be formed by determining a resultant melt intrinsic viscosity similar to determining a resultant injection pressure as described above and injection molding a number of articles at varying resultant melt intrinsic viscosities and measuring the intrinsic viscosity of the molded article.

A number of factors can affect melt viscosity such as various physical parameters of the mold 145, including the number of cavities in a mold 145, the temperature of the molten polymer 115, the temperature of the mold 145, the fill rate of the molten polymer 115 into the mold 145, and the like. By determining a relationship between melt viscosity and solution intrinsic viscosity at different temperatures for a particular injection molding apparatus 100 with a particular type of mold 145, including a particular number of mold 145 cavities, these factors are accounted for in the relationship. Thus, when an injection molding process is performed and abnormal melt viscosities are observed or determined (typically from a high moisture content in the resin), inline detection can be made by an operator from the converter or by the controller to interrupt the injection molding process to reduce or eliminate molded articles having unacceptable qualities and characteristics.

The present technology includes various methods for operating the injection molding apparatus 100. In one embodiment, a method includes measuring a pressure of the fluid 130 to obtain a pressure measurement, the fluid 130 configured to actuate the piston 110 of the injection unit 105. The pressure measurement is converted to an intrinsic viscosity value. An indication of when the intrinsic viscosity value falls below a threshold value or is outside of a range is then provided.

Methods for operating the injection molding apparatus can include various additional aspects. For example, the indication of when the intrinsic viscosity value falls below the threshold value or is outside of the range can include one or more of a visual signal, an audible signal, an electronic signal, and a wireless signal. The method can further include intervening in an operation of the injection molding apparatus 100 when the intrinsic viscosity value falls below the threshold value or is outside of the range. Intervening in the operation of the injection molding apparatus 100 can include one or more of: (a) interrupting operation of the injection molding apparatus 100; (b) recording that an injection molded article has an intrinsic viscosity loss defect; (c) checking a dew point of a dryer of the injection molding apparatus; (d) checking an airflow of the dryer of the injection molding apparatus 100; (e) checking a loading condition of the dryer of the injection molding apparatus 100; (f) verifying a polymer recipe of the injection molding apparatus 100; (g) checking a polymer additive of the injection molding apparatus 100; (h) verifying a temperature of the injection molding apparatus 100; (i) calibrating a temperature sensor of the injection molding apparatus 100; and (j) checking a mold parameter of the injection molding apparatus 100. In certain embodiments, the intervening includes performing a plurality of (a) through (j). Particular embodiments of the intervening step include at least three of (a) through (j), at least four of (a) through (j), more than four of (a) through (j), any number of (a) through (j), and each of (a) though (j).

The present technology further includes performing any of the various methods described herein with any of the various embodiments of the injection molding apparatus described herein.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. An injection molding apparatus comprising:
an injection unit including a piston, the piston configured to force a molten polymer through a bore;
a conduit including a fluid, the conduit coupled to the injection unit and the fluid configured to actuate the piston of the injection unit to force the molten polymer through the bore;
a pressure sensor coupled to the conduit, the pressure sensor configured to provide a pressure measurement of the fluid within the conduit; and
a converter configured to receive the pressure measurement of the fluid within the conduit from the pressure sensor, the converter operable to convert the pressure measurement to an intrinsic viscosity value.

2. The injection molding apparatus of claim 1, further comprising a mold fluidly coupled to the bore.

3. The injection molding apparatus of claim 1, further comprising a plasticizing unit fluidly coupled to the injection unit, the plasticizing unit configured to provide the molten polymer to the injection unit.

4. The injection molding apparatus of claim 1, further comprising a pump configured to pressurize the fluid within the conduit to actuate the piston of the injection unit to force the molten polymer through the bore.

5. The injection molding apparatus of claim 4, wherein the pressure sensor is coupled to the conduit at a position between the pump and the piston.

6. The injection molding apparatus of claim 1, wherein the pressure sensor comprises an electronic pressure sensor.

7. The injection molding apparatus of claim 6, wherein the electronic pressure sensor comprises a piezoresistive strain sensor, a capacitive sensor, a magnetic sensor, a piezoelectric sensor, an optical sensor, a potentiometric sensor, or a resonant sensor.

8. The injection molding apparatus of claim 1, wherein the converter wirelessly receives the pressure measurement of the fluid within the conduit from the pressure sensor.

9. The injection molding apparatus of claim 1, wherein the converter is configured to provide an indication of when the intrinsic viscosity value falls below a threshold value or is outside of a range.

10. The injection molding apparatus of claim 9, wherein the threshold value or the range is dependent on a member selected from the group consisting of a mold configuration, a pressure measurement obtained at a point when the piston of the injection unit is forcing the molten polymer through the bore, an average of pressure measurements obtained at more than one point when the piston of the injection unit is forcing the molten polymer through the bore, and combinations thereof.

11. The injection molding apparatus of claim 9, wherein the indication is a member selected from the group consisting of a visual signal, an audible signal, an electronic signal, a wireless signal, and combinations thereof.

12. The injection molding apparatus of claim 9, further comprising a controller configured receive the indication of when the intrinsic viscosity value falls below the threshold value or is outside of the range and thereby intervene in the operation of the injection molding apparatus.

13. A method of operating an injection molding apparatus comprising:
measuring a pressure of a fluid to obtain a pressure measurement, the fluid configured to actuate a piston of an injection unit;
converting the pressure measurement to an intrinsic viscosity value; and
providing an indication of when the intrinsic viscosity value falls below a threshold value or is outside of a range.

14. The method of claim 13, wherein the indication is a member selected from the group consisting of a visual signal, an audible signal, an electronic signal, a wireless signal, and combinations thereof.

15. The method of claim 13, further comprising intervening in an operation of the injection molding apparatus when the intrinsic viscosity value falls below the threshold value or is outside of the range, wherein the intervening includes at least one of:
(a) interrupting operation of the injection molding apparatus;
(b) recording that an injection molded article has an intrinsic viscosity loss defect;
(c) checking a dew point of a dryer of the injection molding apparatus;
(d) checking an airflow of the dryer of the injection molding apparatus;
(e) checking a loading condition of the dryer of the injection molding apparatus;
(f) verifying a polymer recipe of the injection molding apparatus;
(g) checking a polymer additive of the injection molding apparatus;
(h) verifying a temperature of the injection molding apparatus;
(i) calibrating a temperature sensor of the injection molding apparatus; and
(j) checking a mold parameter of the injection molding apparatus.

16. The method of claim 15, wherein the intervening includes a plurality of (a) through (j).

17. The method of claim 15, wherein the intervening includes at least three of (a) through (j).

18. The method of claim 15, wherein the intervening includes at least four of (a) through (j).

19. The method of claim 15, wherein the intervening includes each of (a) though (D.

20. The method of claim 14, wherein the injection molding apparatus comprises:
the injection unit including the piston, the piston configured to force a molten polymer through a bore;
a conduit including the fluid, the conduit coupled to the injection unit and the fluid configured to actuate the piston of the injection unit to force the molten polymer through the bore;
a pressure sensor coupled to the conduit, the pressure sensor configured to provide the pressure measurement of the fluid within the conduit; and
a converter configured to receive the pressure measurement of the fluid within the conduit from the pressure sensor, the converter operable to convert the pressure measurement to the intrinsic viscosity value.
